(19) United States
(12) Patent Application Publication
(10) Pub. No.: US 2009/0244787 A1
(43) Pub. Date: Oct. 1, 2009

(54) PERPENDICULAR HEAD WITH WIDE TRACK WRITING CAPABILITY AND METHODS OF MEDIA TESTING

(76) Inventors: Alan Paul Giorgi, Cupertino, CA (US); Wesley LeRoy Hillman, Morgan Hill, CA (US); Wen-Chien David Hsiao, San Jose, CA (US); Edward Hin Pong Lee, San Jose, CA (US); Tony Mello, San Jose, CA (US); Randall George Simmons, San Jose, CA (US)

Correspondence Address: ZILKA-KOTAB, PC- HIT, P.O. BOX 721120, SAN JOSE, CA, 95172-1120, US

(21) Appl. No.: 12/059,539

(22) Filed: Mar. 31, 2008

(51) Int. Cl. G11B 5/33

(52) U.S. Cl. 360/313

(57) ABSTRACT

A system according to one embodiment comprises a head having a perpendicular writer, the writer comprising: a first pole structure having a pole tip positioned towards an air bearing surface of the head, the first pole structure having a portion that is recessed from an extent of the pole tip closest the air bearing surface; a return pole having an end positioned towards the air bearing surface of the head; and a gap between the first pole structure and the return pole, wherein the recessed portion is recessed less than about 1.25 microns relative to the extent of the pole tip closest the air bearing surface. Additional embodiments as well as methods are presented.

### FIELD OF THE INVENTION

The present invention relates to data storage, and more particularly, this invention relates to perpendicular write heads and testing data storage systems using wide track writing during repeat testing.

### BACKGROUND OF THE INVENTION

Media certification testing is performed for all disk drive media and is used to screen the media for defects in the magnetic layers. These defects include scratches, protrusions, voids from missing media material and other media defects. Testing is generally done on special testers that include a spindle for holding and spinning the disks, head positioners (or actuators) for precisely locating the test head on the disk surface, and computers, controllers and software controlling the tester and interpreting the test results.

Generally, media certification testing is done by writing a track of bit signals with a write head or element and then reading back signal with a read head or element. If there are any defects on the disk the read back signal (output) will be compromised.

Writing test tracks on PMR media using prior art LMR heads does not properly orient the media bits and does not properly test all of the media structures. Writing test tracks with prior art PMR heads have limitations with the narrower Write widths. Due to the narrow write width of perpendicular write heads, the process of testing perpendicular media is generally very time consuming.

### SUMMARY OF THE INVENTION

A system according to one embodiment comprises a head having a perpendicular writer, the writer comprising: a first pole structure having a pole tip positioned towards an air bearing surface of the head, the first pole structure having a portion that is recessed from an extent of the pole tip closest the air bearing surface; a return pole having an end positioned towards the air bearing surface of the head; and a gap between the first pole structure and the return pole, wherein the recessed portion is recessed less than about 1.25 microns relative to the extent of the pole tip closest the air bearing surface. Additional embodiments as well as methods are presented.

A magnetic head according to another embodiment comprises a head having a perpendicular writer, the writer comprising: a first pole structure having a pole tip positioned towards an air bearing surface of the head; a return pole having an end positioned towards the air bearing surface of the head; and a gap between the first pole structure and the return pole, wherein a write width of the writer is greater than about 1.5 microns.

A method for testing a magnetic medium according to yet another embodiment comprises loading a first disk on a tester; positioning a head over a starting point of the first disk; enabling a write function of the head; moving the head positioner laterally to perpendicularly write data in a spiral track, the written track having a width of greater than about 1.5 microns; reading a previously written portion of the spiral track; and comparing the read previously written portion of the spiral track and corresponding written data on the spiral track to determine if there is a defect on the first disk.

A method for testing a magnetic medium according to a further embodiment comprises loading a first disk on a tester; positioning a head over a starting point of the first disk; enabling a write function of the head; perpendicularly writing data in about concentric tracks, the written tracks each having a width of greater than about 1.5 microns; reading a previously written portion of at least one of the concentric tracks; and comparing the read previously written portion of the at least one track and corresponding written data on the at least one track to determine if there is a defect on the first disk.

Other embodiments, aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIG. 1A is a schematic diagram of a magnetic head having a centered writer and reader according to one embodiment.

FIG. 1B is a schematic diagram of a magnetic head having an offset writer and reader according to one embodiment.

FIG. 1C is a schematic diagram of a magnetic head having an offset writer and reader according to one embodiment.

FIG. 1D is a schematic diagram of a magnetic head having completely offset writer and reader according to one embodiment.

FIG. 2A is a schematic diagram of a conventional writer main pole.

FIG. 2B is a schematic diagram of a wider writer main pole according to one embodiment.

FIG. 3 is a chart that illustrates the measured experimental results of the maximum field strength, measured in Oersteds (Oe), versus the track width, measured in nanometers (nm), for a conventional writer.

FIG. 4 is a chart that illustrates graphically the measured write field strength, measured in Oersteds (Oe), versus the stitch pole recess, measured in microns (μm).

FIG. 5 is a chart that illustrates graphically the measured write field strength, measured in Oersteds (Oe), versus the distance from the track center, measured in microns (μm).

FIG. 6A is a schematic diagram of a disk with a spiral track and a writer positioned opposite a reader according to one embodiment.

FIG. 6B is a schematic diagram of a disk with at least one concentric track, and a head including a centered writer and reader according to one embodiment.

FIG. 6C is a schematic diagram of a disk with a spiral track and a head including single track offset writer and reader according to one embodiment.

FIG. 6D is a schematic diagram of a disk with a spiral track and a head including multiple tracks offset writer and reader according to one embodiment.

FIG. 7 is an air bearing surface (ABS) view of a magnetic head including a writer.

FIG. 8A is a cross-sectional view of one particular embodiment of a magnetic head taken from Line 8 in FIG. 7.

FIG. 8B is a cross-sectional view of one particular embodiment of a magnetic head.

FIG. 8C is a cross-sectional view of one particular embodiment of a magnetic head.

FIG. 8D is a cross-sectional view of one particular embodiment of a magnetic head.

FIG. 8E is a partial top down view of the head of FIG. 8D.

FIG. 9A is an enlarged view of components of a magnetic head according to one embodiment.

FIG. 9B is an enlarged view of components of a magnetic head according to another embodiment.

FIG. 10 is a flow diagram of a method according to one embodiment.

FIG. 11 is a flow diagram of a method according to one embodiment.

FIG. 12 is a flow diagram of a method according to one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

The following description discloses several preferred embodiments of magnetic storage systems, as well as operation and/or component parts thereof and/or testing/reliability systems and methods for magnetic storage systems.

In one general embodiment, a system comprises a head having a perpendicular writer, the writer comprising a first pole structure having a pole tip positioned towards an air bearing surface of the head, the first pole structure having a portion that is recessed from an extent of the pole tip closest the air bearing surface. Also, the perpendicular writer includes a return pole having an end positioned towards the air

In another general embodiment, a magnetic head comprises a head having a perpendicular writer, the writer comprising a first pole structure having a pole tip positioned towards an air bearing surface of the head and a return pole having an end positioned towards the air bearing surface of the head. Also, the perpendicular head includes a gap between the first pole structure and the return pole, where a write width of the writer is greater than about 1.5 microns.

In a further general embodiment, a method for testing a magnetic medium comprises loading a first disk on a tester, positioning a head over a starting point of the first disk, enabling a write function of the head, moving the head positioner laterally to perpendicularly write data in a spiral track with the written track having a width of greater than about 1.5 microns, reading a previously written portion of the spiral track, and comparing the read previously written portion of the spiral track and corresponding written data on the spiral track to determine if there is a defect on the first disk.

In yet another general embodiment, a method for testing a magnetic medium comprises loading a first disk on a tester, positioning a head over a starting point of the first disk, enabling a write function of the head, perpendicularly writing data in about concentric tracks where the written tracks each have a width of greater than about 1.5 microns, reading a previously written portion of at least one of the concentric tracks, and comparing the read previously written portion of the at least one track and corresponding written data on the at least one track to determine if there is a defect on the first disk.

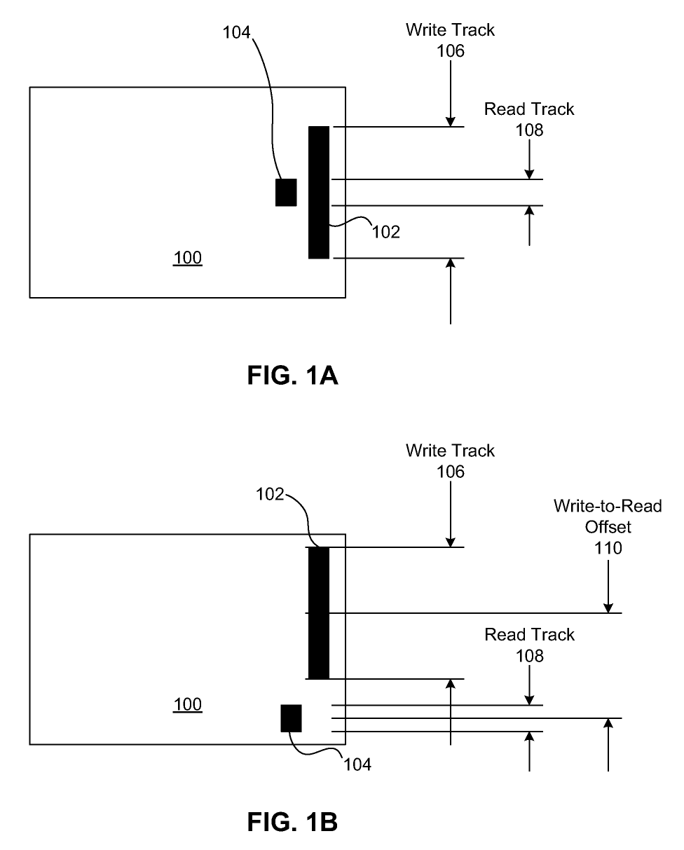

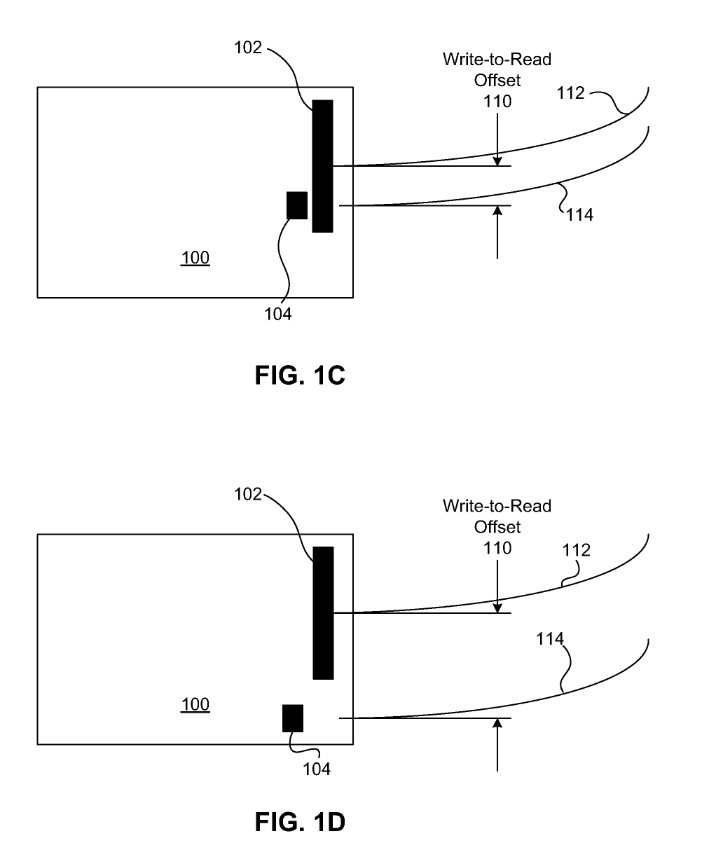

Referring now to FIG. 1A, a head 100 has a perpendicular writer 102 that is as wide as or wider than the reader 104 according to one embodiment. In this configuration, the center of the writer 102 and the reader 104 are horizontally aligned. Therefore, there is no offset between the write track 106 and the read track 108; the write track 106 is simply wider than the read track 108.

FIG. 1B illustrates a schematic diagram of a head 116 in which a writer 102 is offset from a reader 104 according to one embodiment. In this configuration, the writer 102 is offset from the reader 104 by the write-to-read offset 110. If the write-to-read offset 110 is equal to or greater than Equation 1 below, then the write track 106 and read track 108 will be completely offset from one another.

$$WRO \geq \frac{1}{2} ( WT + RT ) \qquad Equation 1$$

where WRO is the write-to-read offset 110, WT is the width of the write track 106, and RT is the width of the read track 108.

FIG. 1C illustrates a schematic diagram of a head 118 in which a writer 102 is offset from a reader 104 according to another embodiment. In this configuration, the writer 102 is offset from the reader 104 by the write-to-read offset 110. Also, the tracks are illustratively depicted as being of a spiral nature. However, unlike in FIG. 1B, here the write-to-read offset 110 is not greater than or equal to Equation 1; therefore, the write track and read track are not completely offset from one another.

FIG. 1D illustrates a schematic diagram of a head 120 in which a writer 102 is offset from a reader 104 according to another embodiment. In this configuration, the writer 102 is offset from the reader 104 by the write-to-read offset 110. Once again, the tracks are illustratively depicted as being spiral in nature. In this embodiment, the write-to-read offset 110 is greater than or equal to Equation 1; therefore, the write track and read track are completely offset from one another.

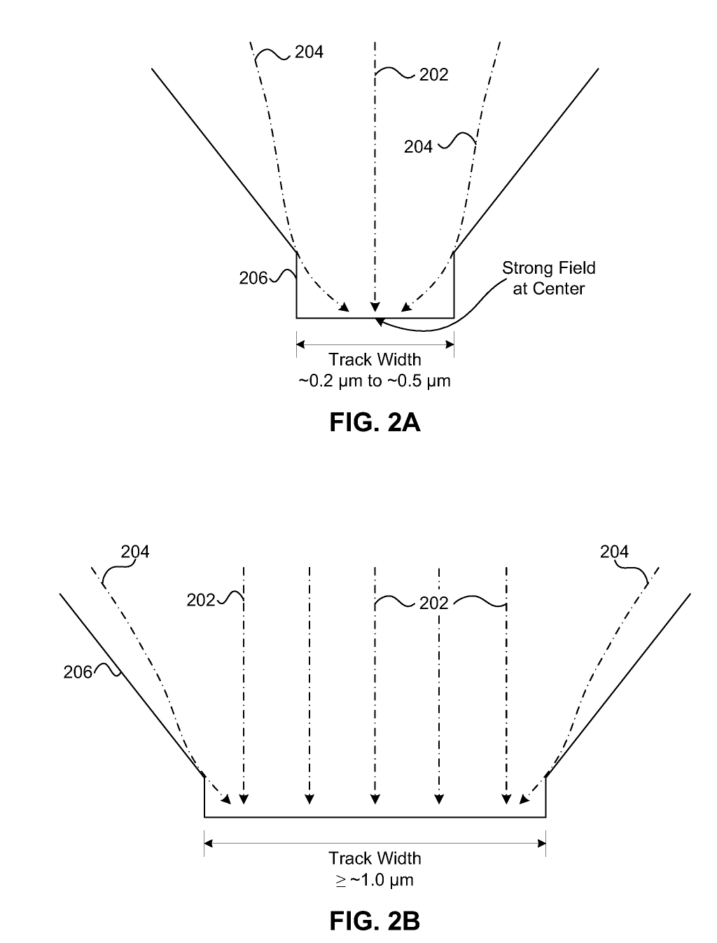

Now referring to FIGS. 2A and 2B, the shape of the write pole 206 is schematically shown as it exists in conventional writers in FIG. 2A, and according to one embodiment in FIG. 2B. In FIGS. 2A and 2B, a write pole 206 is shown with edge effect flux lines 204 and straight flux lines 202.

In FIG. 2A, a conventional write pole 206 with a track width of less than about 0.2 microns is shown. In this configuration, a stronger magnetic field tends to develop near the center of the write pole 206 due to straight flux lines 202 and edge-effect flux lines 204 converging near the center of the write pole tip due to use of the flare to concentrate flux, rather than near the edges. In conventional designs, when the track width is increased to greater than about 1.0 micron, the strength of the magnetic field generated by the write pole 206 tends to be weaker in the center and tends to be stronger around the edges when using a flare to concentrate flux. As the width of the write pole tip is increased beyond about 1.0 micron, this effect is even more exaggerated.

In FIG. 2B, a write pole 206 is schematically shown according to one embodiment. When the track width is increased to greater than about 1.0 micron, the strength of the magnetic field generated by the write pole 206 tends to be about consistent across a width of the writer, as discussed in more detail below.

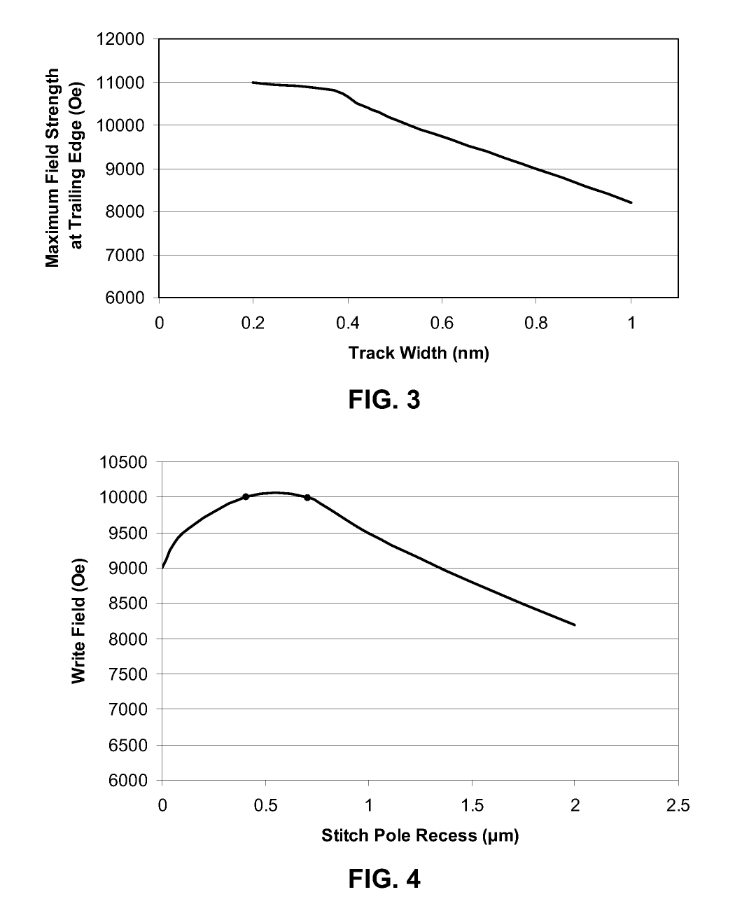

FIG. 3 is a chart that illustrates graphically the measured experimental results of the maximum field strength—measured in Oersteds (Oe)—versus the track width—measured in nanometers (nm) of a conventional head. The track width is directly related to the width of the write pole tip. As this chart shows, the more the track width is increased, the weaker the maximum field at the trialing edge of the writer. This effect is observed with conventionally shaped write poles that are widened, and manipulating the shape of the write pole tip may offset this measured effect.

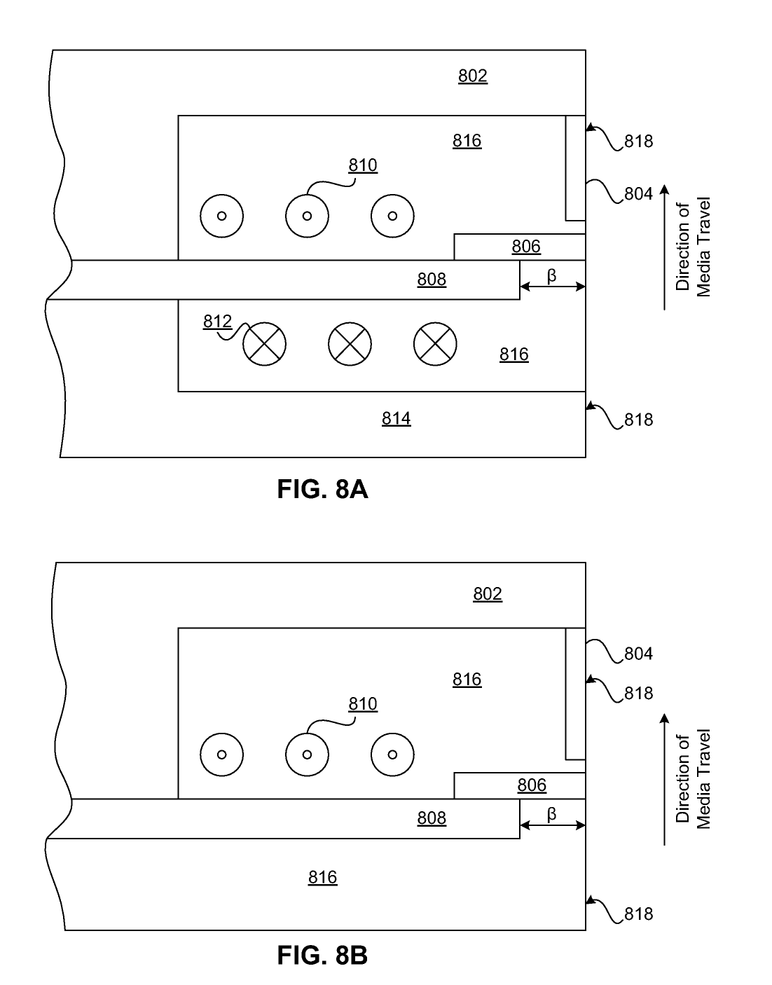

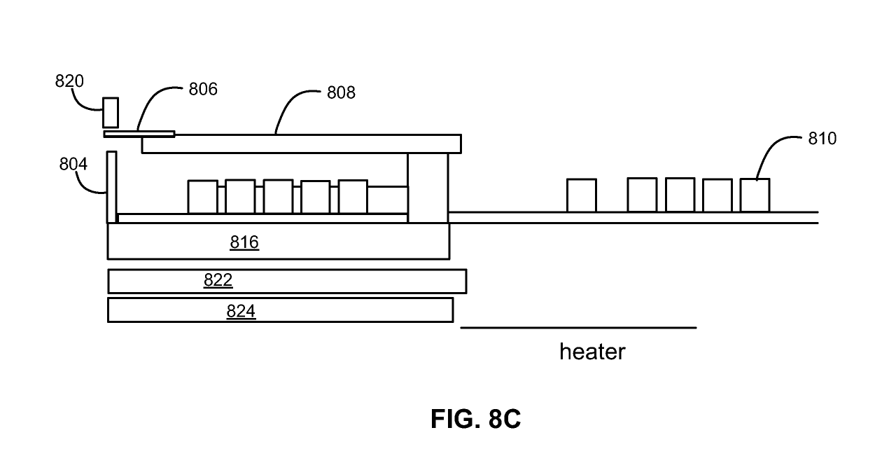

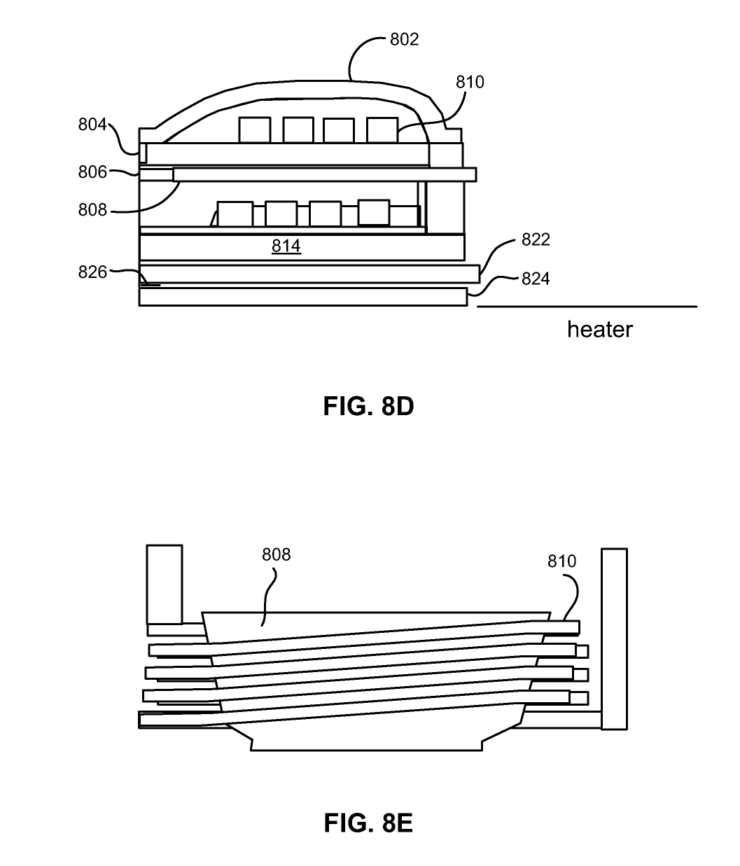

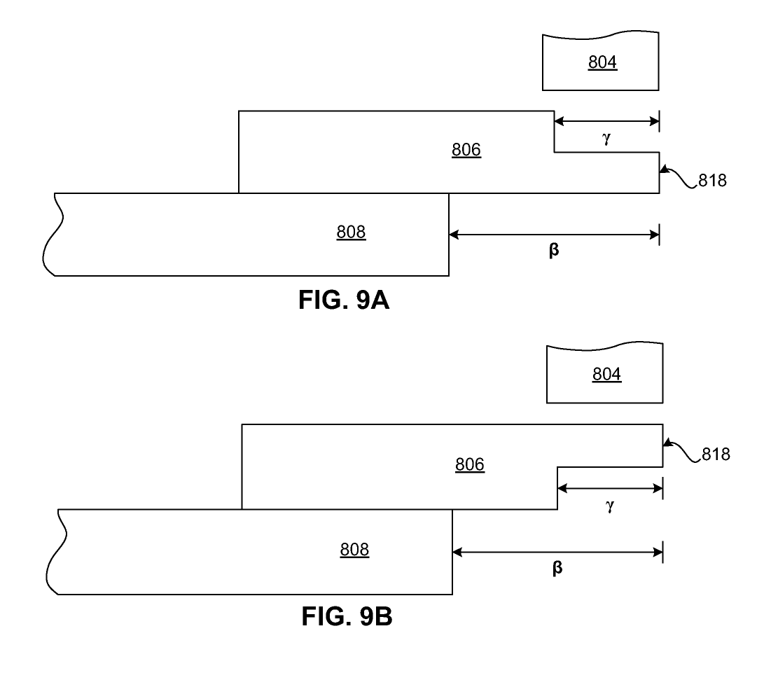

FIG. 4 is a chart that illustrates graphically the measured write field strength—measured in Oersteds (Oe)—versus the stitch pole recess—measured in microns (μm) of one embodiment of the present invention. The stitch pole recess is identified in FIGS. 8A and 8B as distance β, or alternatively in FIGS. 9A and 9B as distance γ. As this chart illustrates, a stitch pole recess of between about 0.4 micron and 0.7 micron creates a write field having its highest strength. After about 0.7 micron of stitch pole recess, the write field strength declines somewhat linearly.

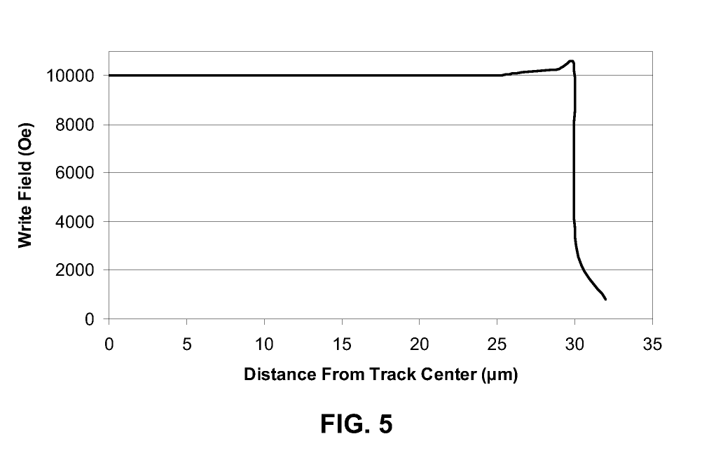

FIG. 5 is another chart that illustrates graphically the measured write field strength—measured in Oersteds (Oe)—versus the distance from the track center—measured in microns (μm) of one embodiment. The distance from the track center is illustrated in FIG. 7 as distance φ. As this chart shows, the write field strength is near its maximum value at the center of a write pole, and stays near the maximum, peaking at a distance of near 30 micron from the center of the write pole, then declining rapidly to be below the medius coercivity at 30.1 microns from the center of the write pole.

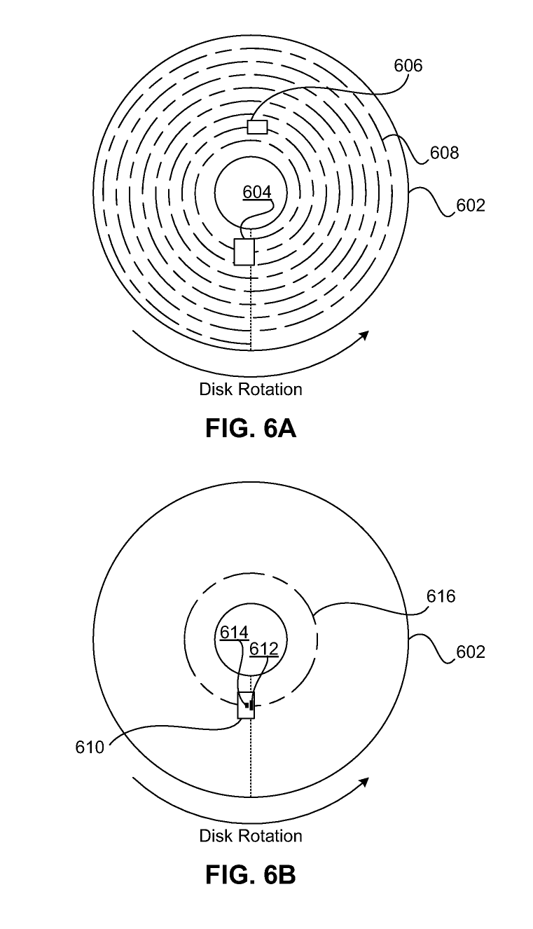

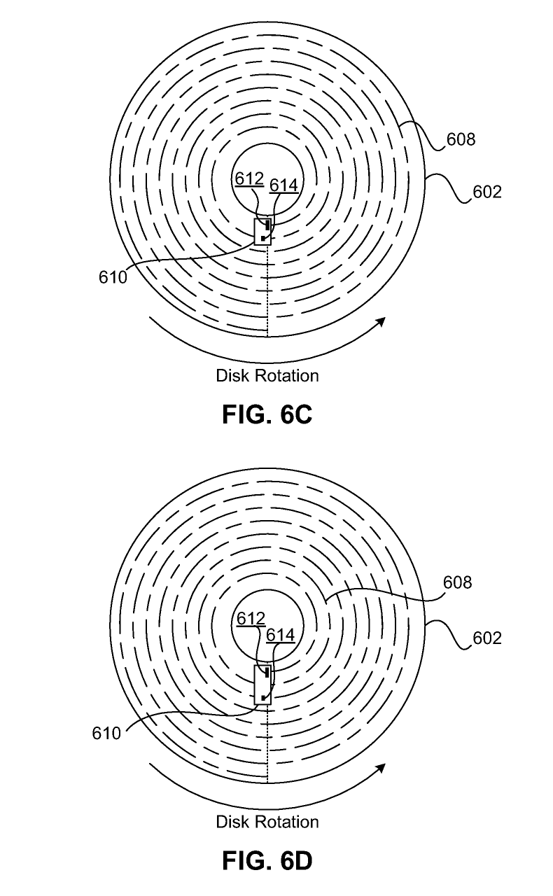

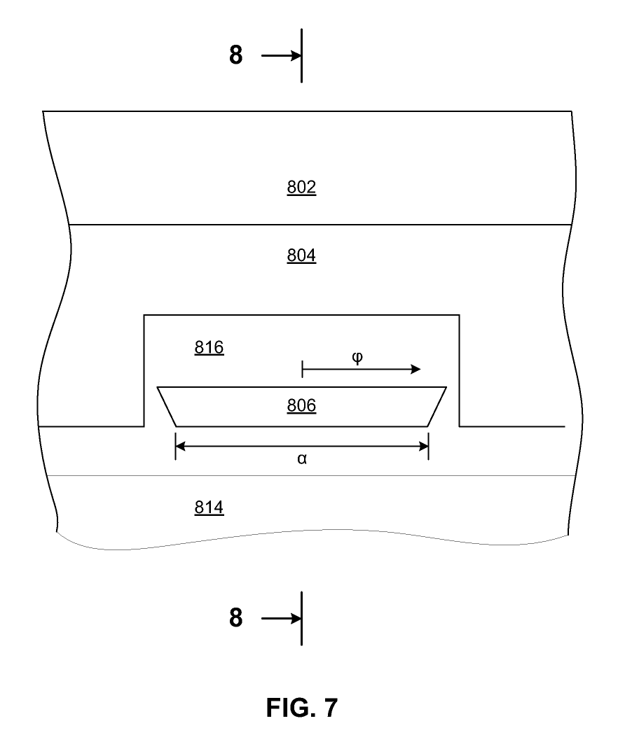

FIG. 6A is a schematic diagram of one embodiment of a system that includes a disk 602 with spiral tracks 608 laid thereon. Oriented above the disk in opposing positions are a write head 604 and a read head 606. The disk rotation, as indicated by the arrow below the disk, will rotate the portion of the disk that the write head 604 is positioned above around and up to the read head 606 as both heads sit above the same track portion. This orientation may be used to test a disk once the tracks have been laid down by writing data with the write head 604, and reading the data with the read head 606. Any discrepancy between what is written and what is read may indicate a problem with the disk or track orientation.

FIG. 6B is a schematic diagram of one embodiment of a system that includes a disk 602 with at least one concentric track 616 laid thereon. A head 610 is positioned above the disk 602 which has a writer 612 and a reader 614 centered about the concentric track 616. The writer 612 is wider than the reader 614. This orientation may be used to test a disk once the tracks have been laid down by writing data with the write head 604, and reading the data with the read head 606. Any discrepancy between what is written and what is read may indicate a problem with the disk or track orientation.

FIG. 6C is a schematic diagram of one embodiment of a system that includes a disk 602 with spiral tracks 608 laid thereon. Oriented above the disk is a head 610 which has a writer 612 and a reader 614. The writer 612 is offset from the reader 614 so that writer 612 is positioned above a spiral track adjacent to a track that the reader 614 is positioned above. The disk rotation, as indicated by the arrow below the disk, will rotate the portion of the disk that the writer 612 is positioned above one counter-clockwise revolution around and back to the reader 614. This orientation may be used to test a disk once the tracks have been laid down by writing data with the writer 612, and reading the data with the reader 614. Any discrepancy between what is written and what is read may indicate a problem with the disk or track orientation.

FIG. 6D is a schematic diagram of another embodiment of a system that includes a disk 602 with spiral tracks 608 laid thereon. Oriented above the disk is a head 610 which has a writer 612 and a reader 614. The writer 612 is offset from the reader 614 so that writer 612 is positioned above a spiral track that is separated by one track from a track that the reader 614 is positioned above. The disk rotation, as indicated by the arrow below the disk, will rotate the portion of the disk that the writer 612 is positioned above two counter-clockwise revolutions around and back to the reader 614. This orientation may be used to test a disk once the tracks have been laid down by writing data with the writer 612, and reading the data with the reader 614. Any discrepancy between what is written and what is read may indicate a problem with the disk or track orientation.

In another embodiment, the writer 612 is offset laterally from a centerline of the reader 614 in a direction generally perpendicular to the written track. In this approach, the reader may still be aligned with a portion of the writer in the media movement direction as shown in FIG. 1C, or can be spaced therefrom relative to the direction of media movement as shown in FIGS. 1B and 1D. Also, the tracks may be in a spiral orientation or in concentric circles, and the system may further comprise a spin stand coupled to the head. Also, the disk 602 may rotate clockwise, with the positioning of the writer 612 and reader 614 being reversed.

In yet another approach, as shown in FIG. 1A, the reader may be generally aligned with a centerline of the writer.

FIG. 7 is an air bearing surface (ABS) view of one embodiment of a writer that includes a main pole 806, insulation 816, optional wrap around shield 804, and return pole 802. In FIG. 7, the distance φ represents the distance from the centerline of the main pole, as the main pole 806 is wider than in conventional write heads. Distance α indicates the width of the main pole 806 which dictates the track width that can be written. In a preferred embodiment, α is greater than about 1.5 microns. Also, the writer may be characterized as emitting about a uniform flux across the width a of the main pole 806.

In other embodiments, the width a of the main pole 806 is greater than about 10 microns or greater than about 50 microns. Also, the writer may comprise a trailing shield (not shown in FIG. 7) or a wrap around shield 804 or both a trailing shield and a wrap around shield 804.

While a second return pole 814 is shown, this is optional. Likewise, various components may be added or removed in various permutations of the disclosed embodiment.

FIG. 8A is a cross-sectional view of a particular embodiment taken from Line 8 in FIG. 7. In FIG. 8A, helical coils 810 and 812 are used to create magnetic flux in the stitch pole 808, which then delivers that flux to the main pole 806. Coils 810 indicate coils extending out from the page, while coils 812 indicate coils extending into the page. Stitch pole 808 may be recessed from the ABS 818 by a distance β. Insulation 816 surrounds the coils and may provide support for some of the elements. The direction of the media travel, as indicated by the arrow to the right of the diagram, moves the media past the lower return pole 814 first, then past the stitch pole 808, main pole 806, trailing shield 804 which may be connected to the wrap around shield (not shown), and finally past the upper return pole 802. Each of these components may have a portion in contact with the ABS 818. The ABS 818 is indicated across the right side of the figure.

Perpendicular writing is achieved by forcing flux through the stitch pole 808 into the main pole 806 and then to the surface of the disk positioned towards the ABS 818.

FIG. 8B is a schematic diagram of one embodiment which uses looped coils 810, sometimes referred to as a pancake configuration, to provide flux to the stitch pole 808. The stitch pole then provides this flux to the main pole 806. In this orientation, the lower return pole is optional. Insulation 816 surrounds the coils 810, and may provide support for the stitch pole 808 and main pole 806. The stitch pole may be recessed from the ABS 818 by a distance β. The direction of the media travel, as indicated by the arrow to the right of the diagram, moves the media past the stitch pole 808, main pole 806, trailing shield 804 which may be connected to the wrap around shield (not shown), and finally past the upper return pole 802 (all of which may or may not have a portion in contact with the ABS 818). The ABS 818 is indicated across the right side of the figure. The trailing shield 804 may be in contact with the main pole 806 in some embodiments.

The extent β that the stitch pole is recessed aids in forming the constant flux along the write width. In illustrative embodiments, the distance β is greater than 0 microns and less than about 1.25 microns, less than about 1 micron, less than about 0.7 microns, between about 1.2 and about 0.4, etc. relative to the extent of the main pole 806 tip closest to the ABS 818. However, the distance β can be higher or lower than these illustrative ranges.

FIG. 8C illustrates another embodiment having similar features to the head of FIG. 8A and implemented as a piggyback head. Two shields 804, 820 flank the stitch pole 808 and main pole 806. Also sensor shields 822, 824 are shown. The sensor (not shown) is typically positioned between the sensor shields 822, 824.

FIGS. 8D and 8E illustrate another embodiment having similar features to the head of FIG. 8B including a helical coil 810. This embodiment is shown implemented in a piggyback head. Also sensor shields 822, 824 are shown. The sensor 826 is typically positioned between the sensor shields 822, 824.

Note that in any of the embodiments described herein, a heater may be embedded in the structure for such things as inducing thermal protrusion.

FIGS. 9A and 9B are schematic diagrams showing alternate embodiments each having an effective recess. Such embodiments are usable in various embodiments and/or in combination with embodiments such as those shown in FIGS. 7, 8A and 8B.

In FIG. 9A, in one particular embodiment, a perpendicular writer is shown that includes a stitch pole 808 that may be recessed from the ABS 818 by a distance β and a main pole 806 that may have a recessed portion on the trailing edge and a portion that may be in contact with the ABS 818 on the leading edge. The recessed portion of the main pole 806 may be recessed by a distance γ from the ABS plane 818. In illustrative embodiments, the distance γ is greater than 0 microns and less than about 1.25 microns, less than about 1 micron, less than about 0.7 microns, between about 1.2 and about 0.4, etc. relative to the extent of the main pole 806 tip closest to the ABS 818. However, the distance γ can be higher or lower than these illustrative ranges. The distance β that the stitch pole is recessed is less important in embodiments having a notched main pole such as these. The trailing shield 804 may be in contact with the main pole 806.

FIG. 9B is a schematic diagram of one embodiment that includes a main pole 806 with a recessed portion on the leading edge that may be recessed by a distance γ from the ABS plane 818. Also, the portion of the main pole 806 in contact with the ABS 818 may be on the trailing edge. The stitch pole 808 may be recessed from the ABS 818 by a distance β. The trailing shield 804 may be in contact with the main pole 806.

In another approach, the extent of the recess of the end of the main pole 806 relative to the end of the trailing shield 804 or upper return pole is less than about 1.0 micron.

In yet another approach, the extent of the recess of the end of the main pole 806 relative to the end of the trailing shield 804 or upper return pole is between about 0.4 micron and about 1.2 microns.

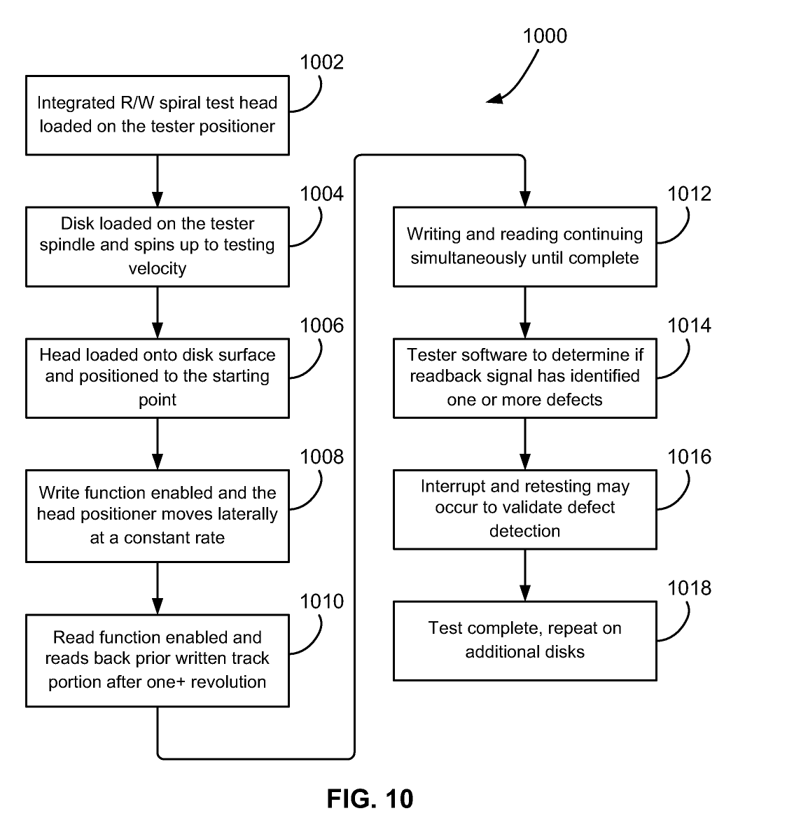

FIG. 10 is a flow diagram of a method 1000 according to one embodiment. In operation 1002, an integrated read/write spiral test head is loaded on the tester positioner. In operation 1004, a disk is loaded on the tester spindle and spins up to testing velocity. In operation 1006, a head is loaded onto the disk surface and is positioned to the starting point. In operation 1008, a write function is enabled and the head positioner moves laterally at a constant rate. In operation 1010, a read function is enabled and reads back prior written track portion after one or more disk revolutions. In operation 1012, writing and reading continue simultaneously until completed. In operation 1014, tester software determines if the readback signal has identified one or more defects. In operation 1016, interrupt and retesting may occur to validate the defect detection. In operation 1018, the test completes and may be repeated on additional disks.

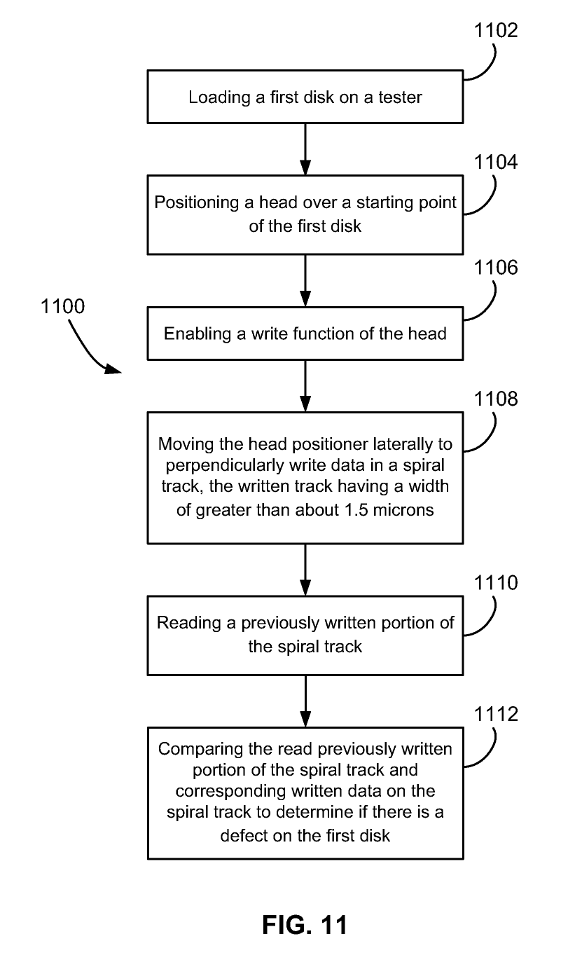

FIG. 11 is a flow diagram of a method 1100 for testing a magnetic medium according to one embodiment. In operation 1102, a first disk is loaded on a tester. In operation 1104, a head is positioned over a starting point of the first disk. In operation 1106, a write function of the head is enabled. In operation 1108, data is perpendicularly written in a spiral track having a width of greater than about 1.5 microns by moving the head positioner laterally. In operation 1110, a previously written portion of the spiral track is read. In operation 1112, the read previously written portion of the spiral track is compared to the corresponding written data on the spiral track to determine if there is a defect on the first disk.

In other embodiments, the written track has a width of greater than about 10 microns or about 50 microns. Also, in another embodiment, the method for testing a magnetic medium may further include writing a marker in a single pass for marking a defect on the disk.

In another approach, a read width is less than the write width, wherein the reading includes reading multiple adjacent portions (e.g., strips) of the spiral track. In this approach, the adjacent portions may be directly adjacent or spaced from each other in the spiral track.

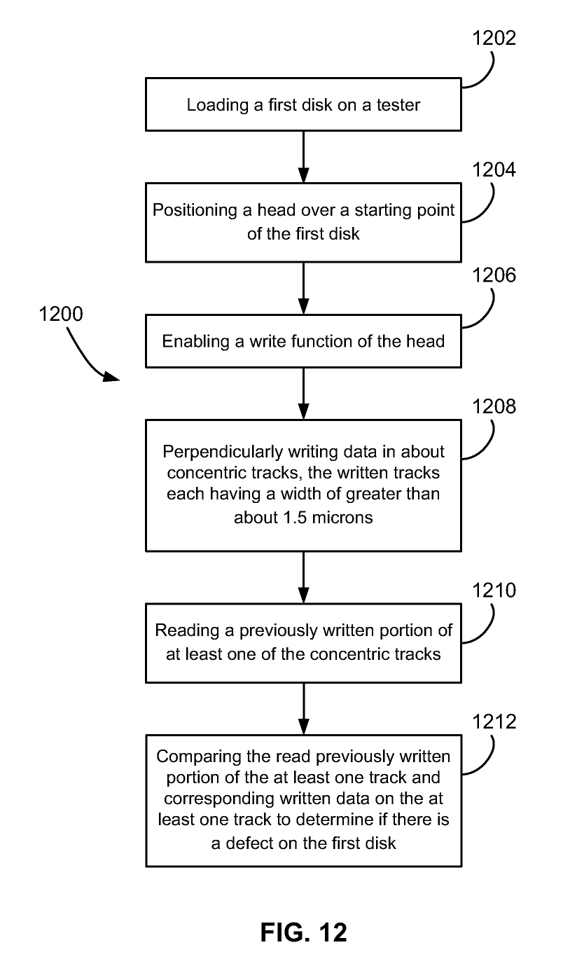

FIG. 12 is a flow diagram of a method 1200 for testing a magnetic medium according to another embodiment. In operation 1202, a first disk is loaded on a tester. In operation 1204, a head is positioned over a starting point of the first disk. In operation 1206, a write function of the head is enabled. In operation 1208, data is perpendicularly written in about concentric tracks each having a width of greater than about 1.5 microns. In operation 1210, a previously written portion of at least one of the concentric tracks is read. In operation 1212, the read previously written portion of the at least one track is compared to the corresponding written data on the at least one track to determine if there is a defect on the first disk.

In other embodiments, the written track has a width of greater than about 10 microns or about 50 microns. Also, in another embodiment, the method for testing a magnetic medium may further include writing a marker in a single pass for marking a defect on the disk.

In another approach, a read width is less than the write width, wherein the reading includes reading multiple adjacent portions (e.g., strips) of the spiral track. In this approach, the adjacent portions may be directly adjacent or spaced from each other in the spiral track.

It should be noted that methodology presented herein for at least some of the various embodiments may be implemented, in whole or in part, in hardware (e.g., logic), software, by hand, using specialty equipment, etc. and combinations thereof.

Embodiments of the present invention can also be provided in the form of a computer program product comprising a computer readable medium having computer code thereon. A computer readable medium can include any medium capable of storing computer code thereon for use by a computer, including optical media such as read only and writeable CD and DVD, magnetic memory, semiconductor memory (e.g., FLASH memory and other portable memory cards, etc.), RAM, etc. Further, such software can be downloadable or otherwise transferable from one computing device to another via network, wireless link, nonvolatile memory device, etc.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A system, comprising:
a head having a perpendicular writer, the writer comprising:
a first pole structure having a pole tip positioned towards an air bearing surface of the head, the first pole structure having a portion that is recessed from an extent of the pole tip closest the air bearing surface;
a return pole having an end positioned towards the air bearing surface of the head; and
a gap between the first pole structure and the return pole,
wherein the recessed portion is recessed less than about 1.25 microns relative to the extent of the pole tip closest the air bearing surface.

2. The system of claim 1, wherein the write width of the writer is greater than about 1.5 microns.

3. The system of claim 2, wherein the writer is characterized as emitting about a uniform flux across the write width thereof.

4. The system of claim 1, wherein the write width of the writer is greater than about 10 microns.

5. The system of claim 1, wherein the write width of the writer is greater than about 50 microns.

6. The system of claim 1, further comprising at least one of a trailing shield and a wrap around shield.

7. The system of claim 1, wherein an extent of the recess of the end of the first pole structure relative to the end of the return pole is less than about 1.0 microns.

8. The system of claim 1, wherein an extent of the recess of the end of the first pole structure relative to the end of the return pole is between about 0.4 microns and about 1.2 microns.

9. The system of claim 1, further comprising a reader offset laterally from a centerline of the writer in a direction generally perpendicular to the written track.

10. The system of claim 1, further comprising a spin stand coupled to the head.

11. A magnetic head, comprising:
a head having a perpendicular writer, the writer comprising:
a first pole structure having a pole tip positioned towards an air bearing surface of the head;
a return pole having an end positioned towards the air bearing surface of the head; and
a gap between the first pole structure and the return pole,
wherein a write width of the writer is greater than about 1.5 microns.

12. The head of claim 11, wherein the writer is characterized as emitting about a uniform flux across the write width thereof.

13. The head of claim 11, wherein the write width of the writer is greater than about 10 microns.

14. The head of claim 11, wherein the write width of the writer is greater than about 50 microns.

15. The head of claim 11, further comprising a reader offset laterally from a centerline of the writer in a direction generally perpendicular to the written track.

16. A method for testing a magnetic medium, comprising:
loading a first disk on a tester;
positioning a head over a starting point of the first disk;
enabling a write function of the head;
moving the head positioner laterally to perpendicularly write data in a spiral track, the written track having a width of greater than about 1.5 microns;
reading a previously written portion of the spiral track; and
comparing the read previously written portion of the spiral track and corresponding written data on the spiral track to determine if there is a defect on the first disk.

17. The method of claim 16, wherein the written track has a width of greater than about 10 microns.

18. The method of claim 16, wherein the written track has a width of greater than about 50 microns.

19. The method of claim 16, further comprising writing a marker in a single pass for marking a defect on the disk.

20. The method of claim 16, wherein a read width is less than the write width, wherein the reading includes reading multiple adjacent portions of the spiral track.

21. A method for testing a magnetic medium, comprising:
loading a first disk on a tester;
positioning a head over a starting point of the first disk;
enabling a write function of the head;
perpendicularly writing data in about concentric tracks, the written tracks each having a width of greater than about 1.5 microns;
reading a previously written portion of at least one of the concentric tracks; and
comparing the read previously written portion of the at least one track and corresponding written data on the at least one track to determine if there is a defect on the first disk.

22. The method of claim 21, wherein the at least one written track has a width of greater than about 10 microns.

23. The method of claim 21, wherein the at least one written track has a width of greater than about 50 microns.

24. The method of claim 21, further comprising writing a marker in a single pass for marking a defect on the disk.

25. The method of claim 21, wherein a read width is less than the write width, wherein the reading includes reading multiple portions of each written track.
